(19) United States
(12) Patent Application Publication
(10) Pub. No.: US 2024/0020532 A1
(43) Pub. Date: Jan. 18, 2024

(54) INTELLIGENT SYSTEMATIC AGENT: AN ENSEMBLE OF DEEP LEARNING AND EVOLUTIONARY STRATEGIES

(71) Applicant: PricewaterhouseCoopers LLP, New York, NY (US)

(72) Inventors: Prasang GUPTA, Mumbai (IN); Shaz HODA, New York, NY (US); Anand Srinivasa RAO, Lexington, MA (US)

(73) Assignee: PricewaterhouseCoopers LLP, New York, NY (US)

(21) Appl. No.: 18/174,000

(22) Filed: Feb. 24, 2023

Related U.S. Application Data
(60) Provisional application No. 63/390,237, filed on Jul. 18, 2022.

(51) Int. Cl. G06N 3/08

(52) U.S. Cl. CPC G06N 3/08

(57) ABSTRACT

A first step in training a deep learning model may include generating data representing a plurality of historical episodes. Each historical episode may be divided into a sequence of time units, and historical information may be associated with each time unit. Next, for each historical episode of the plurality of episodes, a respective training action sequence may be generated using an evolutionary algorithm. A training data set comprising a plurality of training data points may then be generated. Each of the plurality of training data points may comprise an action extracted from a training action sequence generated by the evolutionary algorithm. The deep learning model may be trained using training data set to generate future actions to be executed at current or future time units.

### CROSS REFERENCE TO RELATED APPLICATIONS

This application claims the benefit of U.S. Provisional Application No. 63/390,237, filed Jul. 18, 2022, the entire contents of which is incorporated herein by reference.

### FIELD

The present disclosure relates to methods for training deep learning models such as neural networks.

### BACKGROUND

Entities in a wide range of fields frequently encounter problems with solutions that take the form of schedules or sequences of events or actions. Whether or not a given schedule or action sequence is the best solution to a particular problem may depend on the timing and order of actions in the schedule or sequence along with a large number of (often disparate) factors associated with the problem being solved. Since the relationships between a given schedule or action sequence and said factors are often complex and difficult to accurately quantify, artificial intelligence techniques (e.g., deep learning), which excel at identifying patterns within large, complicated data sets, can be leveraged to solve such problems.

### SUMMARY

Artificial intelligence techniques such as deep learning can be leveraged to train models to efficiently and accurately generate schedules or action sequences associated with a specific problem or task. However, training such models is often challenging due to a lack of readily available training data. Training data used to train an artificial intelligence model typically includes a set of exemplary inputs (e.g., information or data related to the problem being solved that may be provided by a user) and a set of exemplary solutions, each of which may correspond to a particular subset of inputs. During training, the artificial intelligence model may “learn” relationships between the inputs and the exemplary solutions. Accordingly, training an artificial intelligence model to generate schedules or action sequences may require training data that includes numerous exemplary schedules or sequences so that the model can “learn” how various inputs affect the timing of the various actions.

While raw data related to various actions may be readily available for use as exemplary inputs in a training data set, exemplary schedules or sequences of actions that solve the particular problem given the context provided by the raw data may not be available. Simulating exemplary schedules or action sequences based on raw data may require users to impose constraints that do not accurately reflect real-world situations. Thus, there is need for methods for efficiently and accurately generating training data for training artificial intelligence models to generate optimized schedules or action sequences.

Described herein are systems and methods for generating training data for training deep learning models to provide schedules, actions to be performed at a specified point in time, sequences of actions to be performed over a specified period of time. The schedules or actions may facilitate the completion of a certain task. The disclosed methods employ an evolutionary algorithm to generate training data for the deep learning model. The evolutionary algorithm may use historical data to create exemplary action sequences that may optimize performance for a period of time wherein conditions are similar to those described by the historical data. The exemplary action sequences generated by the evolutionary algorithm can then be used to train the deep learning model to predict action sequences that should be performed by the entity over future periods of time so that the entity can optimize future performance.

The disclosed methods can be employed to train deep learning models (including relatively simple deep learning models such as feed-forward neural networks) to predict optimized action sequences with high precision. Additionally, the methods may be executed in a computationally efficient manner. This may allow the methods to be adapted for use by a variety of entity types (ranging from individual people, who may not have access to high-powered computers, to large companies with abundant resources) in predicting action sequences for a large assortment of different scenarios.

A method for training a deep learning model may comprise generating data representing a plurality of historical episodes, wherein each historical episode is divided into a sequence of time units, wherein historical information is associated with each time unit, generating, using an evolutionary algorithm, for each historical episode of the plurality of episodes, a respective training action sequence comprising a respective sequence of actions that corresponds to the sequence of time units for the historical episode, generating a training data set comprising a plurality of training data points, wherein each of the plurality of training data points comprises an action extracted from a training action sequence generated by the evolutionary algorithm, training a deep learning model using the training data set to generate future actions to be executed at current or future time units, and generating, using the trained deep learning model, a future action for a current or future time unit.

In some embodiments of the method, generating a historical episode of the plurality of historical episodes comprises receiving the historical information, dividing the historical information into a first information subset associated with a first set of time units and a second information subset associated with a second set of time units, wherein the first set of time units and the second set of time units are consecutive, determining a scale factor based on the first information subset, scaling one or more values in the second information subset by the scale factor, and outputting the second set of time units and the scaled second information subset as the historical episode.

In some embodiments of the method, generating, for each historical episode of the plurality of historical episodes, a respective training action sequence comprises randomly generating a set of candidate action sequences corresponding to the sequence of time units for the historical episode, determining a set of fitness values, wherein each fitness value in the set of fitness values corresponds to a candidate action sequence in the set of candidate action sequences, identifying, based on the set of fitness values, a fittest subset of the set of candidate action sequences, generating an updated set of candidate action sequences by modifying candidate action sequences in the fittest subset, iteratively repeating the steps of determining a set of fitness values, identifying a fittest subset, and generating an updated set of candidate action sequences, and identifying, based on the iterative repeating process, a fittest candidate action sequence.

In some embodiments of the method, the training action sequence for each historical episode is the fittest candidate action sequence corresponding to said historical episode that is identified by the evolutionary algorithm.

In some embodiments of the method, the iteratively repeating continues until at least one cessation condition of plurality of cessation conditions is met, wherein the plurality of cessation conditions comprise a total number of iterations exceeds a threshold number of iterations, and one or more fitness values in the set of fitness values exceeds a threshold fitness value.

In some embodiments of the method, modifying candidate actions sequences in the fittest subset comprises switching one or more actions in each action sequence of the fittest subset of from a first action type to a second action type.

In some embodiments of the method, modifying candidate action sequences in the fittest subset of candidate action sequences comprises selecting a first set of actions from a first action sequence of the fittest subset, selecting a second set of actions from a second action sequence of the fittest subset, and combining the first set of actions and the second set of actions to form a third action sequence.

In some embodiments of the method, the historical information associated with each time unit comprises a numerical value.

In some embodiments of the method, each training data point of the plurality of training data points in the training data set further comprises an average value of the numerical value over a set of time units preceding a time unit in a historical episode of the plurality of historical episodes that corresponds to an action sequence from which the action in the training data point was extracted.

In some embodiments of the method, training the deep learning model comprises, for each historical episode, generating a predicted action sequence, comparing the predicted action sequence to the training action sequence that corresponds to the historical episode, adjusting one or more parameters of the deep learning model based on the comparison between the predicted action sequence and the training action sequence in the training data.

In some embodiments of the method, the future action generated by the trained deep learning model is configured to maximize a reward for an entity for the current or future time unit.

In some embodiments of the method, the historical information comprises market performance information.

In some embodiments of the method, each training action sequence generated by the evolutionary algorithm comprises, for each time unit in the historical episode associated with the training action sequence, an indication of whether to execute a purchase of an ETF at that time unit.

In some embodiments of the method, the future action for the current or future time unit that is generated by the deep learning model comprises an indication of whether to execute a purchase of the ETF at said time unit.

In some embodiments of the method, the evolutionary algorithm is a genetic algorithm.

In some embodiments of the method, the deep learning model is a neural network.

In some embodiments of the method, the deep learning model is a feed-forward neural network.

In some embodiments of the method, the feed-forward neural network comprises at least six layers.

In some embodiments of the method, the feed-forward neural network utilizes a rectified linear unit (ReLU) activation function at one or more layers.

A system for training a deep learning model may comprise a user interface and one or more processors communicatively coupled to the user interface and configured to generate data representing a plurality of historical episodes, wherein each historical episode is divided into a sequence of time units, wherein historical information is associated with each time unit, generate, using an evolutionary algorithm, for each historical episode of the plurality of episodes, a respective training action sequence comprising a respective sequence of actions that corresponds to the sequence of time units for the historical episode, generate a training data set comprising a plurality of training data points wherein each of the plurality of training data points comprises an action extracted from a training action sequence generated by the evolutionary algorithm, train a deep learning model using the training data to generate future actions to be executed at current or future time units, generate, using the trained deep learning model, a future action for a current or future time unit, and output, using the user interface, the future action to a user.

A non-transitory computer readable storage medium may store instructions that, when executed by one or more processors of an electronic device, cause the electronic device to generate data representing a plurality of historical episodes, wherein each historical episode is divided into a sequence of time units, wherein historical information is associated with each time unit, generate, using an evolutionary algorithm, for each historical episode of the plurality of episodes, a respective training action sequence comprising a respective sequence of actions that corresponds to the sequence of time units for the historical episode, generate a training data set comprising a plurality of training data points wherein each of the plurality of training data points comprises an action extracted from a training action sequence generated by the evolutionary algorithm, train a deep learning model using the training data set to generate future actions to be executed at current or future time units, and generate, using the trained deep learning model, a future action for a current or future time unit.

### BRIEF DESCRIPTION OF THE FIGURES

The following figures show various systems and methods for training a deep learning model to predict an action sequence. The systems and methods shown in the figures may, in some embodiments, have any one or more of the characteristics described herein.

FIG. 1 shows a system for training a deep learning model to predict an action sequence, according to some embodiments of the present disclosure.

FIG. 2A shows an exemplary episode divided into a plurality of time units, according to some embodiments of the present disclosure.

FIG. 2B shows an exemplary action sequence for an episode, according to some embodiments of the present disclosure.

FIG. 3 shows a method for predicting an action sequence using an ensemble of evolutionary and deep learning strategies, according to some embodiments of the present disclosure.

FIG. 4 shows a method for processing historical data to generate a historical episode, according to some embodiments of the present disclosure.

FIG. 5 shows a method for generating action sequences for historical episodes using a genetic algorithm, according to some embodiments of the present disclosure.

FIG. 6 shows a method for training a deep learning model to predict an action sequence, according to some embodiments of the present disclosure.

FIG. 7 shows the structure of an exemplary deep learning model, according to some embodiments of the present disclosure.

FIG. 8 shows inputs and outputs to a node in a neural network, according to some embodiments of the present disclosure.

FIG. 9 shows a method for predicting an action sequence for a future episode using a trained deep learning model, according to some embodiments of the present disclosure.

FIG. 10 shows a method for predicting an ETF purchasing strategy for a 30-day period using an ensemble of evolutionary and deep learning strategies, according to some embodiments of the present disclosure.

FIG. 11 shows a method for processing historical stock market data to generate a historical episode, according to some embodiments of the present disclosure.

FIG. 12 shows a method for predicting an ETF purchasing strategy for an upcoming time period using a trained deep learning model, according to some embodiments of the present disclosure.

FIG. 13 shows a computer, according to some embodiments of the present disclosure.

### DETAILED DESCRIPTION

Determining ideal sequences of action to be taken by an entity in order to complete a task while optimizing the entity's performance (e.g., by optimizing performance as measured by one or more parameters, for example by maximizing an earned reward) at said task can be a complex and challenging problem. The present disclosure provides methods for training a deep learning model to predict a sequence of actions to be performed by an entity to optimize the entity's performance at a task. The disclosed methods may utilize an evolutionary algorithm to generate exemplary action sequences for historical periods of time using historical data. These exemplary action sequences can then be provided as training data for a deep learning model (e.g., a neural network) to train the deep learning model to predict action sequences for future periods of time.

The methods provided herein may allow even simple neural networks to be trained to make highly accurate action sequence predictions for future periods of time. This, in turn, may allow the disclosed methods to be efficiently executed by computers with basic computational power. Additionally, ensuring that simple neural networks can be trained by the described methods may increase robustness and decrease variability of trained models. As such, the methods may be easily adapted for use by a variety of entity types (ranging from individual people, whose access to high-powered computers may be limited, to large companies with abundant resources) in predicting action sequences for a large assortment of different scenarios (ranging from, e.g., predicting days of a month on which an ETF should be purchased in order to maximize wealth gain to, e.g., predicting days in a season when seeds of a certain type should be planted in order to maximize harvest).

### Ensemble of Evolutionary and Deep Learning Strategies

The methods described herein utilize an evolutionary algorithm to generate training data for training a deep learning (DL) model to predict action sequences that will optimize a performance by an entity. Evolutionary algorithms are optimization algorithms that mimic biological processes and concepts such as reproduction and mutation to create ideal solutions from a population of candidate solutions. Many evolutionary algorithms make little to no initial assumptions about the fitness of the candidate solutions. As a result, evolutionary algorithms rarely require significant adaptation or tweaking by a user to be applied to different problems.

A genetic algorithm (GA) is a type of evolutionary algorithm that transforms a set of candidate solutions toward a set of “fittest” solutions over a series of iterations. Candidate solutions may be provided to a GA as strings of numbers; each number in a string may describe characteristics or properties of the solution that the string represents. The GA causes the candidate solution population to “evolve” by combining and mutating members of the population to form new “generations” of solutions. In each generation, the “fitness” of each member of the solution population may be quantified to determine which solutions should be used to generate the subsequent generation. Evolution of the solution population may continue until one or more stopping conditions are met. Exemplary stopping conditions include the completion of a threshold number of iterations or the achievement of a predetermined fitness quantity by one or more solutions.

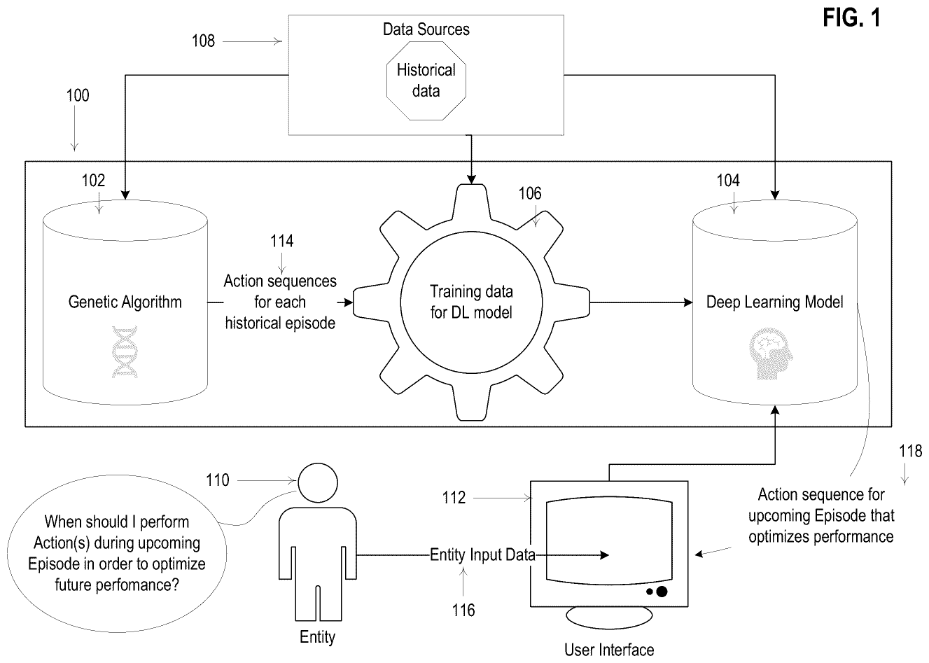

FIG. 1 shows a system for training a deep learning model to predict an action sequence, according to some embodiments of the present disclosure. Specifically, FIG. 1 shows a system 100 configured to use a genetic algorithm 102 to generate training data 106 for training a deep learning model 104. System 100 may comprise one or more electronic devices that are configured to store instructions for training deep learning model 104. The electronic device(s) may include one or more processors configured to execute said instructions. Optionally, system 100 may be configured to receive information from and/or output information to an entity 110 via a user interface 112 (e.g., a display on a monitor). Entity 110 may be an individual person, a group of people, or an organization such as a corporation. System 100 may also be configured to receive information from one or more data sources 108. Data sources 108 may include databases, websites, publications, or any other source of information.

As shown, system 100 may receive data associated with a historical time period from data sources 108. In some embodiments, system 100 may be configured to process the historical data to generate a plurality of historical episodes. An “episode”, as used herein, may refer to a period of time of defined length (e.g., one or more days, one or more years, one or more decades, etc.). A “historical episode” may specifically refer to a period of time in the past. Each episode may be divided into a series of “time units” that represent units of time that make up the episode. For example, a week (the episode) may be divided into seven days (the time units).

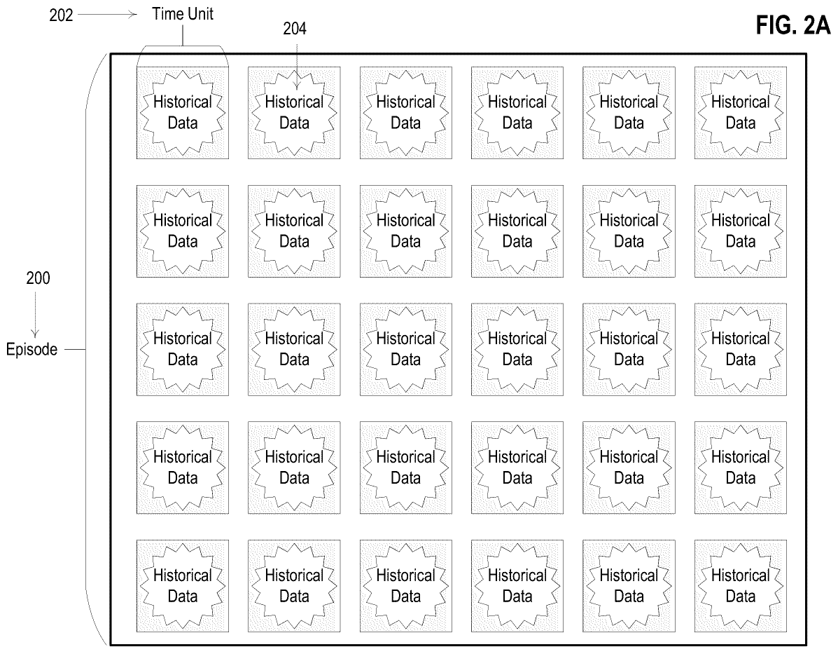

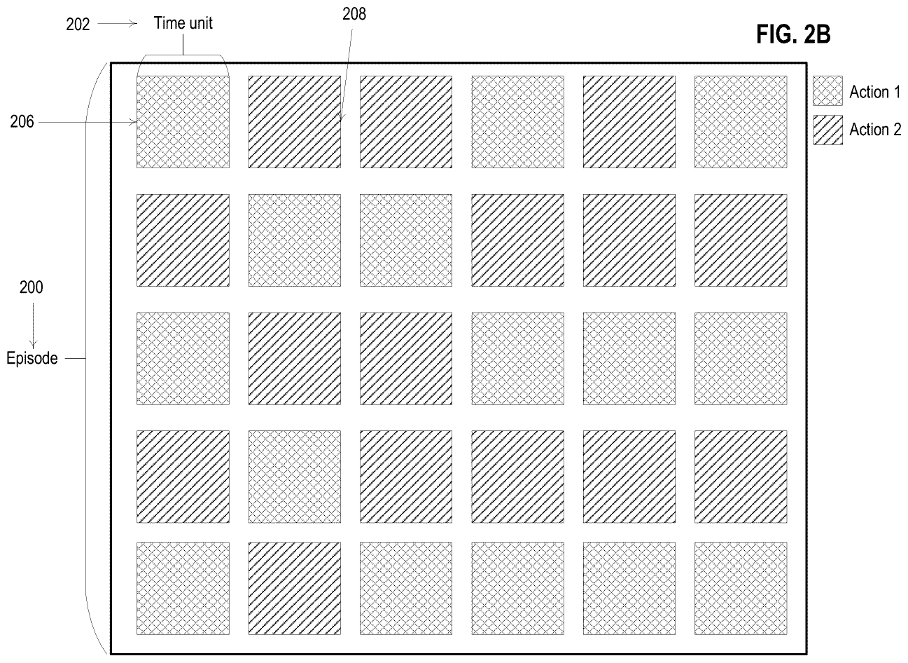

FIG. 2A illustrates an exemplary episode 200. An episode such as episode 200 may represent a period of time such as a day, a week, a month, a year, or a decade. In some embodiments, an episode 200 may be divided into a series of time units 202. Each time unit in an episode such as episode 200 may represent a unit of time such as a minute, an hour, a day, a week, a month, or a year. In some embodiments, an episode may be divided into greater than or equal to 10, 20, 30, 40, 50, 60, 70, 80, 90, or 100 time units 202. In some embodiments, an episode may be divided into less than or equal to 10, 20, 30, 40, 50, 60, 70, 80, 90, or 100 time units 202. Historical data 204 may be associated with each of the plurality of time units 202.

The historical data received from data sources 108 may be input into genetic algorithm 102 to generate optimized action sequences 114 for each historical episode. FIG. 2B illustrates an exemplary action sequence for episode 200. As shown, an action sequence may comprise one or more actions. Specifically, an action sequence may assign an action to each time unit 202 in the episode. In this case, each time unit 202 is assigned either a first action 206 or a second action 208. In some embodiments, an action sequence may comprise greater than or equal to 2, 3, 4, 5, 6, 7, 8, 9, or 10 distinct action types. In some embodiments, an action sequence may comprise less than or equal to 2, 3, 4, 5, 6, 7, 8, 9, or 10 distinct action types.

Historical data received from data sources 108, actions sequences 114, or a combination thereof may be used to form training data 106 for deep learning model 104. System 100 may be configured to train deep learning model 104 using training data 106. After deep learning model 104 is trained, entity 110 may be able to receive predicted action sequences 118 for future episodes from deep learning model 104. Entity 110 may provide input data 116 associated with a future episode to the trained deep learning model (e.g., via a user interface 112). Deep learning model 104 may then provide entity 110 with action sequence 118 (e.g., by displaying action sequence 118 on a display of user interface 112).

### Method for Predicting an Action Sequence

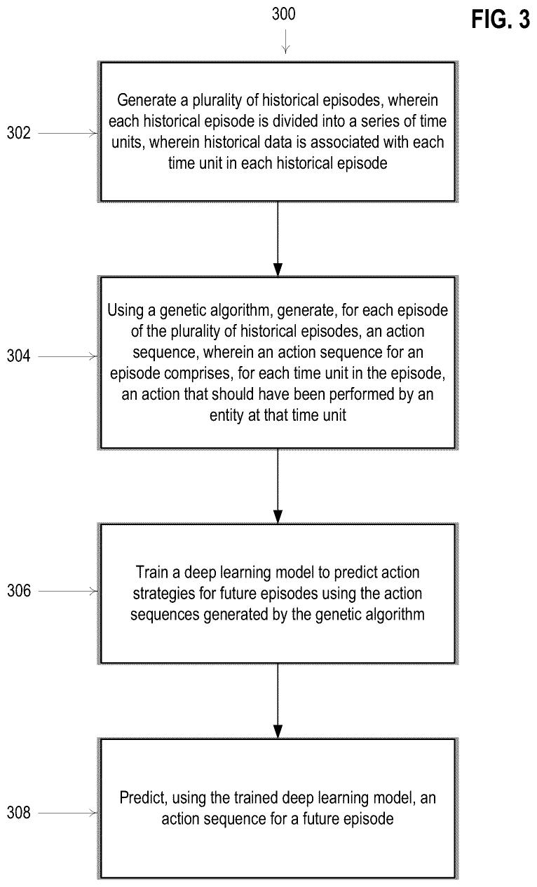

FIG. 3 shows a method for predicting an action sequence using an ensemble of evolutionary and deep learning strategies, according to some embodiments of the present disclosure. Specifically, FIG. 3 shows a method 300 for training a deep learning model to predict action sequences for an entity using training data generated using a genetic algorithm. The action sequences may allow the entity to accomplish a goal or complete a task. In some examples, method 300 may be executed with high efficiency by computer systems with as few or fewer than as 16 cores, allowing smaller entities with limited access to resources utilize method 1000 without requiring said entities to purchase expensive computing equipment.

As shown, method 300 may begin at a step 302, wherein a plurality of historical episodes may be generated. An episode, as illustrated in FIG. 2A, may represent a period of time (e.g., a decade, a year, a month, an hour, etc.) and may be divided into a series of time units. Historical data may be associated with each time unit in each historical episode. The specific time period that an episode represents, along with the number of time units into which an episode is divided and the historical data associated with each time unit, may depend on the task that the entity wants to complete. For example, if the entity is a farmer who wishes to determine the best days in a season to plant a certain type of seed, each historical episode may represent a past season and may be divided into a series of days. The historical data associated with each day might include weather data for that day or information about the soil on that day (e.g., soil moisture levels or soil pH).

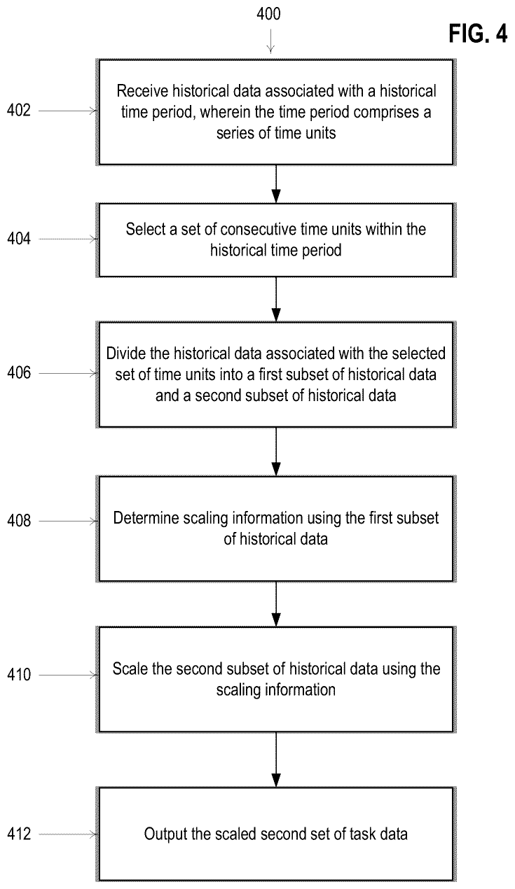

In some embodiments, each historical episode may be generated by processing a set of historical data. FIG. 4 shows a method 400 for processing historical data to generate a historical episode, according to some embodiments of the present disclosure. Step 302 of method 300 may, in one or more examples, include one or more steps of method 400. In some embodiments, method 400 may be executed by one or more processors of a computer system.

Method 400 may begin with a step 402, wherein historical data associated with a historical time period (i.e., a time period prior to the point in time that the entity is executing method 400) may be received. The historical time period may be divided into a sequence of time units. In some embodiments, the historical time period may be one or more days, one or more weeks, one or more months, one or more years, or one or more decades. The time units may be one or more minutes, one or more hours, one or more days, one or more weeks, one or more months, or one or more years.

Next, at a step 404, a set of consecutive time units may be selected from the historical time period. For instance, if the historical time period is a decade, step 404 may involve selected a month-long time period from within the decade. The historical data associated with the selected set of time units may then be divided into a first subset of historical data and a second subset of historical data in a step 406. In some examples, the first subset of historical data may be associated with a first portion of the set of consecutive time units (e.g., the first half of the time units) and the second subset of historical data may be associated with a second portion of the set of consecutive time units (e.g., the second half of the time units). For example, if the set of consecutive time units represents a month-long period, the first subset of historical data may be historical data from the first two weeks of the month-long period, while the second subset of historical data may be from the last two weeks of the month-long period.

After the historical data associated with the selected set of time units is divided into the first and second subsets in step 406, method 400 may proceed to a step 408, wherein scaling information may be determined based on the first subset of historical data. The scaling information may comprise a scale factor, which may be a numerical factor that quantifies systemic changes in the historical data over the course of the historical time period that was provided in step 402. Such systemic changes may affect the raw values of measurements and numbers within the historical data set but may not have direct influences on the actions that the entity is interested in performing. For instance, if the actions that the entity is interested in performing involve the purchase or sale of an item, the historical data may show that the raw price of the item increases significantly over a period of several decades due to inflation. The actual value of the item, however, may not be directly related to the raw price. The scaling factor may allow the entity to account for such changes so that they do not affect the training of the deep learning model in later steps of method 300. The scaling information may, in addition to or as an alternative to the scaling factor, comprise normalization information or data that may allow the second subset of historical data to be normalized based on the first subset of historical data.

Once the scaling information is determined in step 408, method 400 may move to a step 410, wherein the second subset of historical data may be scaled using the scaling information. In some embodiments, scaling the second subset of historical data may comprise normalizing the second subset of historical data based on a mean value of the first subset of historical data, a mean value of the second subset of historical data, a standard deviation of the first subset of historical data, and/or a standard deviation of the second subset of historical data. This may ensure that the historical data in the second subset is on the same scale as the historical data in the first subset of historical data. This scaled second subset of historical data may then be output in step 412. One or more of the historical episodes received in step 302 of method 300 may be scaled subsets of historical data generated as described in method 400.

After the plurality of historical episodes are generated in step 302 (e.g., using method 400 shown in FIG. 4), method 300 may proceed to a step 304, wherein an action sequence may be generated for each historical episode using a genetic algorithm. An action sequence for an episode, as shown in FIG. 2B, may provide an action for each time unit in the episode. The types of actions performed during an episode, along with the timing of each type of action, may influence the entity's performance during that episode. The genetic algorithm may be configured to generate action sequences that would have optimized the entity's performance for each historical episode, had the entity performed said sequences of actions during the past time periods that the historical episodes represent.

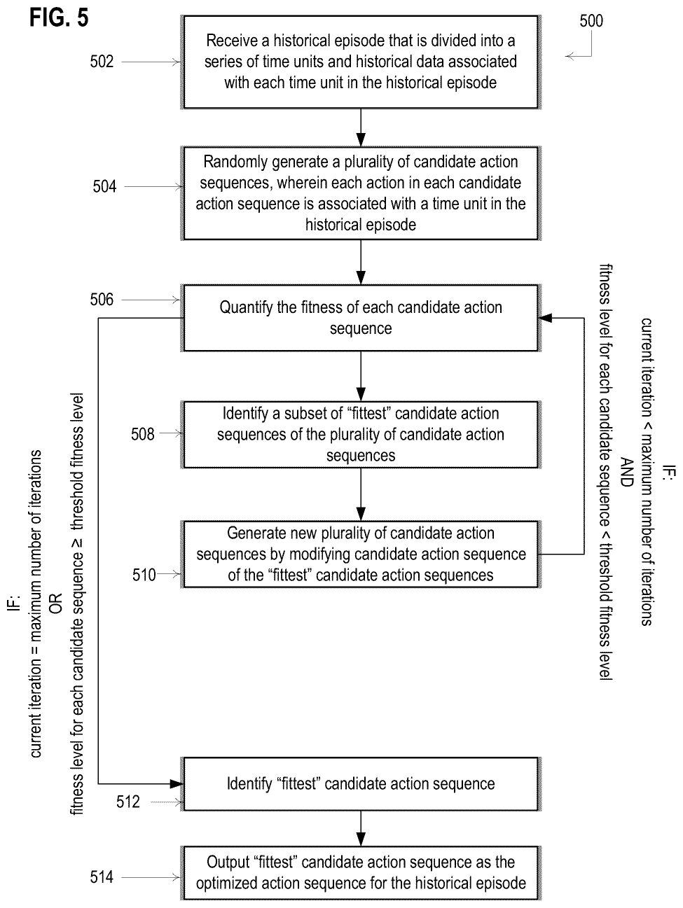

FIG. 5 shows a method 500 for generating action sequences for historical episodes using a genetic algorithm, according to some embodiments of the present disclosure. Method 500 may be executed by one or more processors of a computer system. In some embodiments, step 304 of method 300 may comprise one or more steps of method 500.

As shown, method 500 may begin with a step 502, wherein a historical episode divided into a series of time units may be received. Historical data associated with the actions that the entity wishes to execute may be associated with each time unit. In some embodiments, the historical episode (and associated historical data) may be one of the plurality of historical episodes received in step 302 of method 300.

After the historical episode is received in step 502, method 500 may proceed to a step 504, wherein a plurality of candidate action sequences may be randomly generated. In some embodiments, each action sequence may comprise an action corresponding to each time unit in the historical episode. For example, if the historical episode represents a week and is divided into seven days, the candidate action sequences may include actions corresponding to each of the seven days. In some embodiments, the action sequences may be represented as numerical strings (e.g., strings of binary numbers) whose lengths are equal to the number of time units in the historical episode.

Method 500 may then proceed to a step 506, wherein the “fitness” of each candidate action sequence may be quantified. In one or more examples, the fitness of an action sequence may be quantified using a loss function that is configured to increase in magnitude as the fitness of an action sequence decreases. After the fitness of each candidate action sequence is quantified, a subset of candidate action sequences that are the “fittest” may be identified in a step 508. A new set of candidate action sequences may be generated by modifying action sequences in the subset of “fittest” action sequences in a step 510. In some embodiments, each action sequence in the subset of fittest candidate action sequences may be used to generate multiple new action sequences.

In some embodiments, modification of the fittest candidate action sequences to generate the new set of candidate action sequences may comprise randomly changing (“mutating”) one or more actions in each action sequence (e.g., by changing one or more numerical values in the string of numbers that represents the action sequence). In some embodiments, modification of the fittest candidate action sequences to generate the new set of action sequences may comprise combining (“reproducing”) two or more of the fittest action sequences to produce a new action sequence. For example, half of a first action sequence may be spliced to half of a second action sequence to generate a new action sequence.

A number of parameters may be employed when modifying the fittest candidate action sequences to generate the new set of candidate action sequences. These parameters may include a mutation probability (e.g., a number between 0 and 1 that corresponds to a probability that an action in a fittest candidate action sequence will be randomly changed), a crossover probability (e.g., a number between 0 and 1 that corresponds to a probability that actions in a fittest candidate action sequence will be passed on to a new candidate action sequence), a proportion of action sequences in the new set of candidate action sequences that are identical to action sequences in the set of fittest candidate action sequences, and/or a proportion of the fittest actions in the set of fittest candidate action sequences that are carried over to the new set of candidate action sequences.

After the new set of candidate action sequences is generated in step 510, method 500 may return to step 506, wherein the fitness of each action sequence in the new set of candidate action sequences may be quantified. In some embodiments, method 500 may continue to iterate through steps 506-510 until one or more stopping conditions have been met. In some embodiments, the stopping conditions may be related to a total number of iterations that have been completed or to a quantified fitness level of each candidate action sequence. If the current number of iterations is less than a maximum number of iterations and the fitness level for each candidate action sequence is less than a threshold fitness level, method 500 may continue to iterate through steps 506-510.

In some embodiments, a maximum number of iterations may be provided by a user. In some embodiments, the maximum number of iterations may be greater than or equal to 5, 25, 50, 100, 500, 1000, or 5000 iterations. In some embodiments, the maximum number of iterations may be less than or equal to 5, 25, 50, 75, 100, 500, 1000, or 5000 iterations. The threshold fitness level may also be provided by a user and may depend on the specific actions that the entity wishes to perform, the type of reward that the entity wishes to receive, and the specific method or function used to quantify the fitness level of each actions sequence.

Once the current number of iterations surpasses the maximum number of iterations or the fitness level for each candidate action sequence exceeds the threshold fitness level, method 500 may proceed to a step 514, wherein the “fittest” action sequence of the current set of candidate action sequences may be output. Method 500 may be repeated for each historical episode received in step 302 of method 300 to generate optimized action sequences corresponding to each historical episode.

Once the action sequences have been generated by the genetic algorithm in step 304, method 300 may move to a step 306, wherein a deep learning model may be trained to predict action sequences for future episodes. The action sequences generated using the genetic algorithm may form at least a portion of the training data used to train the deep learning model. The training data may also include historical data associated with the entity's task. As the deep learning model is trained, it may “learn” how the types and timing of actions in an action sequence affect the entity's performance, given the context provided by the historical data.

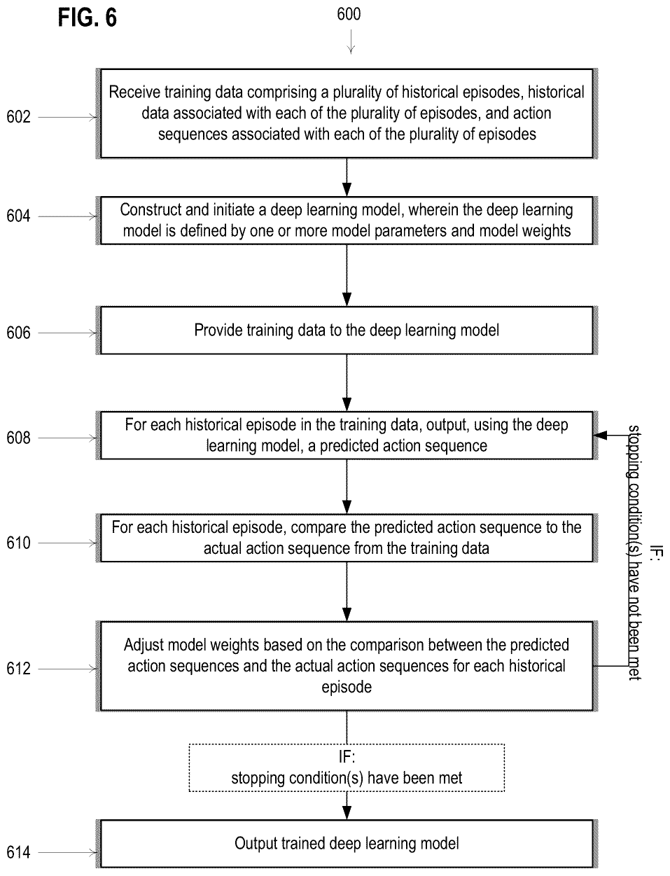

FIG. 6 shows a 600 method for training a deep learning model to predict an action sequence, according to some embodiments of the present disclosure. In some embodiments, step 306 of method 300 may comprise one or more steps of method 600.

In some embodiments, method 600 may comprise a first step 602, wherein training data may be received. Each training data point in the training data set may comprise an action or a set of actions associated with a time unit or a set of time units. Said action(s) may be extracted from action sequences for historical episodes that were generated by a genetic algorithm, as described in method 500 shown in FIG. 5. It is noted that the number of actions included in a given training data point need not be equal to the number of actions in the action sequences generated by the genetic algorithm; each training data point may, for example, only include a single action associated with a single time unit, while the action sequences generated by the genetic algorithm may include a series of actions associated with multiple time units. In other words, each training data point may include an action or set of actions that has been decoupled from preceding and succeeding actions in the respective action sequence. In addition to the action or set of actions, each training data point in the training set may include historical data associated with the time unit or set of time units as well as running averages of data associated with preceding time units.

After the training data has been received in step 602, method 600 may proceed to a step 604, wherein a deep learning model may be constructed and initiated. The deep learning model may be defined by one or more model parameters and model weights. The training data received in step 602 may then be provided to the deep learning model in a step 606. In some embodiments, the training may be normalized prior to being provided to the deep learning model to increase training stability. Subsequently, at a step 608, the deep learning model may be used to predict, for each historical episode in the training data, an action sequence. Next, in a step 610, the predicted action sequences may be compared to the actual action sequences from the training data. Based on the comparisons between the predicted action sequences and the actual action sequences, model weights may be adjusted in a step 612.

If, after the one or more model parameters have been adjusted in step 612, stopping conditions for the training of the deep learning model have not been met, method 600 may return to step 608. Method 600 may iterate through steps 608-612 until one or more stopping conditions are met. The stopping conditions may be associated with a number of times that the entire training data set has passed through the deep learning model (i.e., a number of “epochs”). A threshold number of epochs may be provided by the user. Once this number of epochs exceeds the threshold number, method 600 may proceed to a step 614, wherein the trained deep learning model may be output.

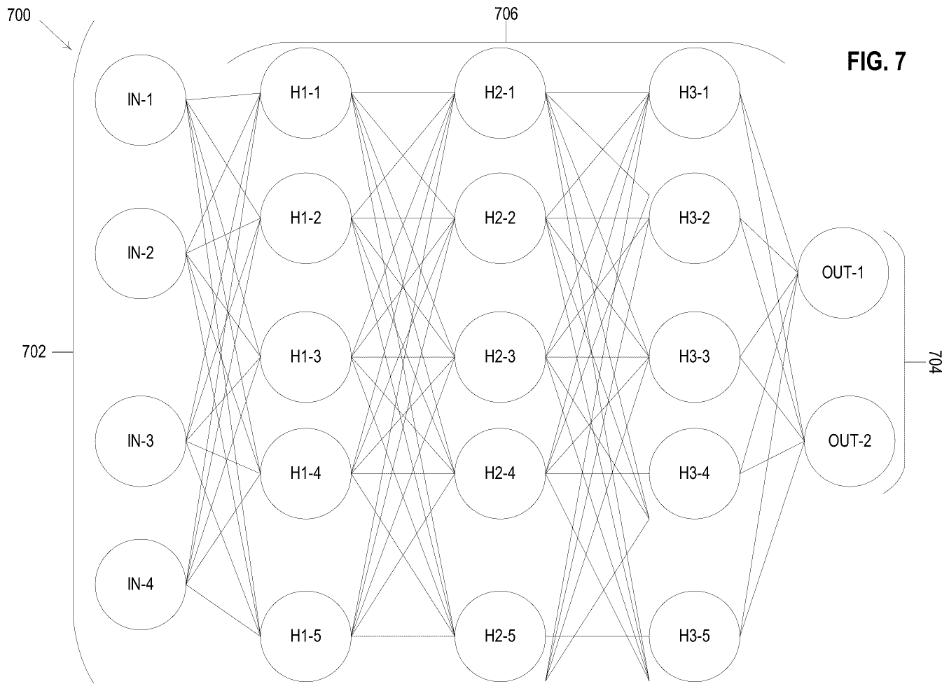

The deep learning model that is trained in step 306 in method 300 may be a neural network. Specifically, the deep learning model may be a feed-forward neural network. FIG. 7 shows the structure of an exemplary feed-forward neural network (FFNN) 700, according to some embodiments of the present disclosure.

Like other neural networks, FFNN 700 may comprise multiple layers of interconnected nodes (e.g., neurons): an input layer 702, an output layer 704, and, optionally, one or more hidden layers 706. The number of nodes in input layer 702 may correspond to the total number of different variables that are input into the neural network. In this case, the number of nodes in input layer 702 may correspond to the number of distinct types of information contained in the historical data for an episode. Similarly, the number of nodes in output layer 704 may correspond to the number of distinct pieces of information that are output from the neural network. Each node in each hidden layers 706 and output layer 704 may be a combination (e.g., a weighted sum) of the nodes in the preceding layer.

The number of hidden layers 706 in FFNN 700 may correspond to the complexity of the data used to train FFNN 700 and the complexity of the information that FFNN 700 outputs. In some embodiments, FFNN may comprise at least 1, at least 2, at least 3, at least 4, at least 5, or at least 6 hidden layers 706. In some embodiments, FFNN may comprise fewer than 1, fewer than 2, fewer than 3, fewer than 4, fewer than 5, or fewer than 6 hidden layers 706.

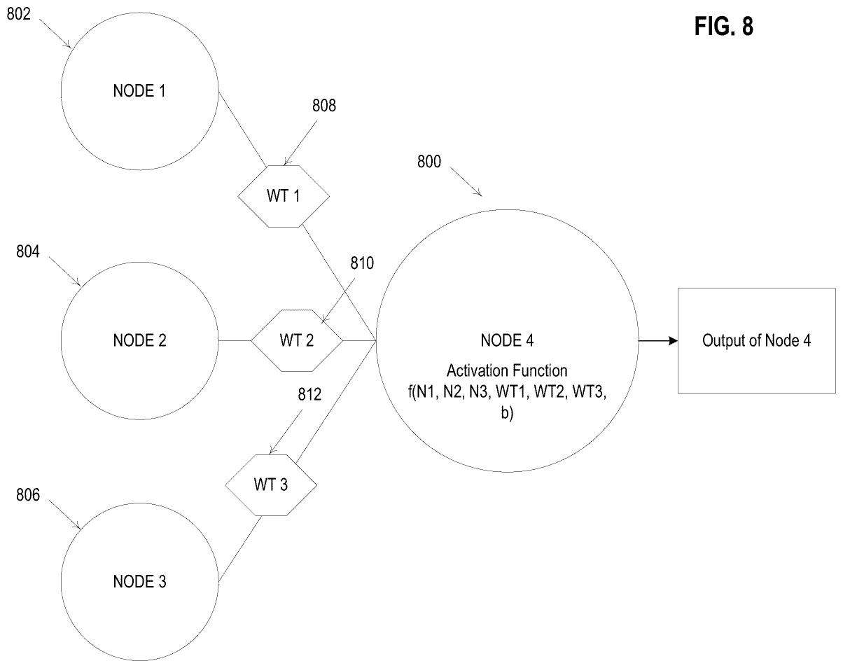

FIG. 8 shows inputs and outputs to a node 800 in a neural network such as FFNN 700, according to some embodiments of the present disclosure. As shown, a first node 802, a second node 804, and a third node 806 may feed into node 800. Node 802 may output a value N₁, node 804 may output a value N₂, and node 806 may output a value N₃. The output values of nodes 802-806 may for a vector A:

$$A = [ \begin{matrix}{N}_{1} \\ {N}_{2} \\ {N}_{3}\end{matrix} ]$$

The value N₄ of node 800 may be combination of the output values of nodes 802-806, given by:

$${N}_{4} = [ \begin{matrix}W {T}_{1} & 0 & 0 \\ 0 & W {T}_{2} & 0 \\ 0 & 0 & W {T}_{3}\end{matrix} ] [ \begin{matrix}{N}_{1} \\ {N}_{2} \\ {N}_{3}\end{matrix} ] = W {T}_{1} {N}_{1} + W {T}_{2} {N}_{2} + W {T}_{3} {N}_{3}$$

where:

$$W = [ \begin{matrix}W {T}_{1} & 0 & 0 \\ 0 & W {T}_{2} & 0 \\ 0 & 0 & W {T}_{3}\end{matrix} ]$$

is a matrix of weight values 808 (WT₁), 810 (WT₂), and 812 (WT₃) that determine how much of the output value of each of nodes 802-806 contributes to the value of node 800. The value of node 800 (possibly shifted by a bias value b) may then be input into an activation function ƒ which may determine whether or what portion of the value of node 800 is passed on to the next layer of the neural network:

Output of Node800=ƒ(N₄+=ƒ(WA+b)

Commonly used activation functions include sigmoid functions, hyperbolic tangent functions, and rectified linear unit functions.

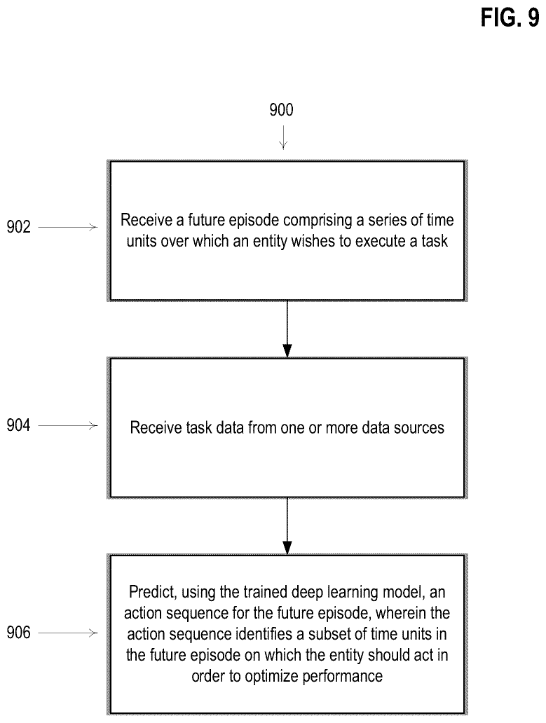

After the deep learning model has been trained using the action sequences generated by the genetic algorithm, method 300 may proceed to step 308, wherein the trained deep learning model may be used to predict an action or sequence of actions for a current or future time unit or set of time units (e.g., a future episode or a portion of a future episode). FIG. 9 shows a method 900 for predicting an action sequence for a future episode using a trained deep learning model, according to some embodiments of the present disclosure. In a first step 902, a future episode may be received from the entity. The future episode may include a time unit or a series of time units over which the entity wishes to complete a task (e.g., by completing a sequence of actions). Next, in a step 904, task data associated with the task that the entity wishes to complete (including, e.g., running averages of data associated with preceding time units) may be received from one or more data sources. Using the task data, the trained deep learning model may predict an action sequence for the future episode in a step 906. The predicted action sequence may identify a subset of time units within the future episode on which the entity should perform a specific action in order to optimize the entity's performance during said episode.

### Example: Predicting ETF Purchasing Strategies

The disclosed methods can be used in any scenario wherein the timing of actions taken by an entity can have considerable impacts on the entity's performance. Described below are exemplary processes for predicting exchange-traded fund (ETF) purchasing strategies for investors. Investors often wish to purchase a certain number of ETFs over a given period of time (e.g., a month). ETF prices at a given time unit (e.g., a day) during the time period of interest may be influenced by an assortment of factors such as politics, weather, and recent economic trends. As a result, ETF prices may be highly volatile over shorter time scales. The purchasing strategy employed by an investor—i.e., the points in time during the period of interest that the investor chooses to purchase ETFs—may have a strong influence on the amount of wealth that the investor builds as a result of the ETF purchases in the long term (e.g., over years or decades). The disclosed methods can be employed to train a deep learning model to predict optimized purchasing strategies (i.e., action sequences) that an investor (i.e., the entity) should take in order to optimize their performance. In this case, optimized performance may correspond to a maximization of the entity's long-term wealth (i.e., the entity's reward).

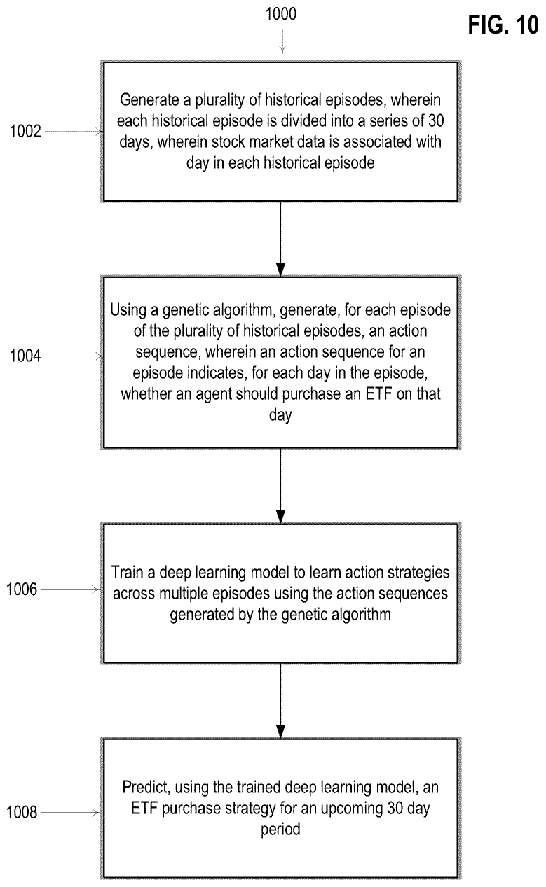

FIG. 10 shows a method for predicting an ETF purchasing strategy for a 30-day period using an ensemble of evolutionary and deep learning strategies, according to some embodiments of the present disclosure. Specifically, FIG. 10 shows a method 1000 for training a deep learning model to predict ETF purchasing strategies for one or more investors using training data generated using a genetic algorithm. In some examples, the ETF purchasing strategies predicted by the trained deep learning model may outperform other purchasing strategies (e.g., a daily investment strategy) by significant margins. Notably, like method 300 shown in FIG. 3, method 1000 may be executed with high efficiency by computer systems with as few as or fewer than 16 cores. This may allow individual investors to utilize method 1000 to predict ETF purchasing strategies without requiring said investors to purchase expensive computers.

As shown, method 1000 may include a first step 1002, wherein a plurality of historical episodes may be generated. Each historical episode may represent a month-long period of time and may be divided into a series of 30 days. Stock market data may be associated with each day in each historical episode. The stock market data may be associated with a particular ETF of interest and include simulated data or actual data from preceding years. Optionally, the stock market data associated with a given day in a given episode may include information such as ETF price on said day or a percent change or rate of change of the ETF price on said day based on the ETF price on one or more preceding days. The stock market data may also include data related to economic, social, political, or environmental events on said day that may have had an influence on investor behavior (and, as a result, on ETF price).

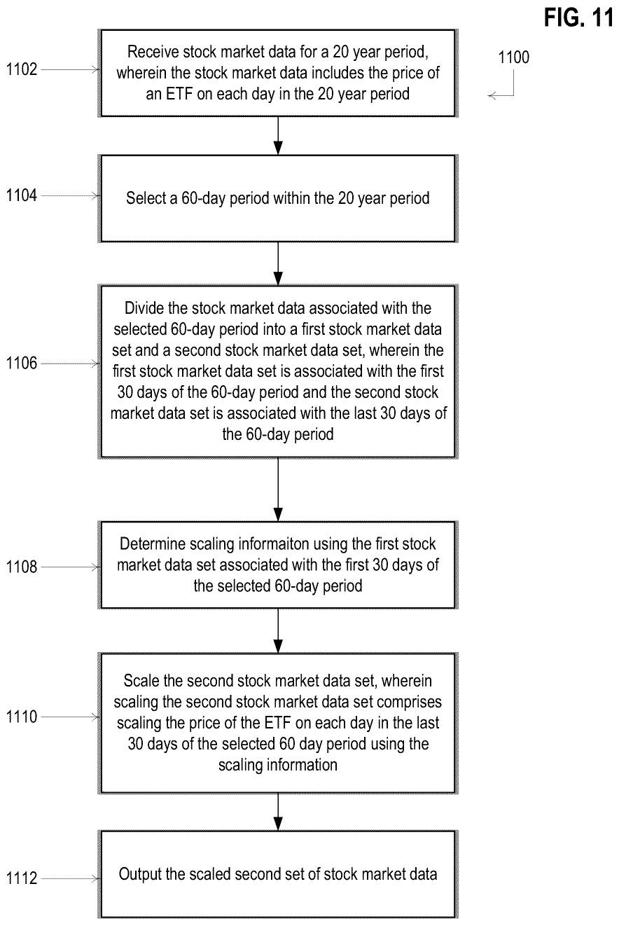

FIG. 11 shows a method for processing historical stock market data to generate a historical episode, according to some embodiments of the present disclosure. Specifically, FIG. 11 shows a method 1100 for generating historical episodes from a twenty-year sample of stock market data. In one or more examples, step 1002 of method 1000 may include one or more steps of method 1100.

Method 1100 may begin with a step 1102, wherein stock market data covering a period of twenty years may be received. The stock market data may be provided by a user and may include information about the price of an ETF on each day of the twenty-year period. Optionally, the stock market data may include additional information, such as the percent change of the price of an ETF on each day relative to the price of the ETF on one or more preceding days or data related to economic, social, political, or environmental events occurring on each day.

After the stock market data is received in step 1102, method 1100 may proceed to step 1104, wherein a period of sixty days may be selected from within the twenty-year period. The sixty days may be consecutive days. Next, in a step 1106, the stock market data associated with the selected sixty-day period may be divided into two data subsets: a first subset comprising the stock market data associated with the first thirty days of the selected sixty-day period, and a second subset comprising the stock market data associated with the last thirty days of the selected sixty-day period.

Due to issues such as inflation, the price of the ETF may change over long periods of time as the value of currency changes. As a result, the average price of the ETF closer to the beginning of the twenty-year period may be far lower than the average price toward the end of the twenty-year period. Accordingly, method 1100 may include a step 1108, wherein the first thirty-day subset created in step 1106 may be used to determine scaling information that captures the relative value (rather than the raw price) of the ETF during the thirty-day period. Subsequently, in a step 1110, the scaling information may be used to scale the price of the ETF on each day in the second thirty-day subset that was created in step 1106. In some embodiments, scaling the second thirty-day subset may comprise normalizing the second thirty-day subset of historical data based on a mean ETF price value of the first thirty-day subset, a mean ETF price value of the second thirty-day subset, a standard deviation of the ETF price values of the first thirty-day subset, and/or a standard deviation of the ETF price values of the second thirty-day subset. The scaled thirty-day subset may then (in a step 1112) be output as a historical episode (e.g., to be used in method 1000 shown in FIG. 10).

After the historical episodes are created in step 1002 (e.g., using method 1100 shown in FIG. 11), method 1000 may proceed to a step 1004, wherein a genetic algorithm may be employed to generate an action sequence for each historical episode. The genetic algorithm may generate an action sequence for each historical episode by evolving an initial set of candidate action sequences for each historical episode toward an optimized action sequence. The optimized action sequence for a historical episode may indicate an ETF purchasing strategy for the episode.

Evolving an initial set of candidate action sequences to generate an optimized action sequence may involve one or more steps of method 500 shown in FIG. 5. In particular, the genetic algorithm used in step 1004 may be configured to quantify the “fitness” of action sequences generated during the “evolution” toward an optimized action sequence (see steps 506-510 of method 400). In some embodiments, the “fitness” of action sequences may be quantified using a loss function configured to quantify the impacts of various actions during an episode. For example, the value of the loss function may be configured to increase for action sequences which indicate that the investor should purchase an ETF too frequently (e.g., on every day of a thirty-day period) or too infrequently (e.g., on only one or two days during a thirty-day period). The loss function may also compare the success of each action sequence to the success of a predefined investment strategy (e.g., a daily investment plan wherein an investor makes fixed ETF purchases on each day of a thirty-day period).

In some embodiments, possible actions that can be taken on each day of each historical episode may be limited to a discrete set of actions. This may constrain the types of actions that can make up an action sequence generated by the genetic algorithm. The loss function used to quantify the fitness of the action sequences generated by the genetic algorithm may be configured to take such constraints into account. For example, the choice of possible actions for each day in a 30-day period may be limited to (1) purchasing no ETFs and (2) purchasing two ETFs. Accordingly, an exemplary loss function may be as follows:

$$= {min}_{a} ( \frac{\frac{\vec{p} \cdot \vec{a}}{{N}_{a = 2}} - \overline{p}}{\overline{p}} ) * ( 2 {N}_{a = 2} ) + {( 1 - \frac{{N}_{a = 2}}{15} )}^{2}$$

Here, the loss [symbol] depends on a price vector [symbol] , an action vector [symbol] , a total number N of days on which two ETF purchases were made, and a daily average price ρ̅. The price vector [symbol] may be a string of thirty numbers that indicates the price of the ETF on each day in a historical episode. The action vector [symbol] may be a string of thirty numbers that represents actions (e.g., purchase/do not purchase) to be taken on each day of a historical episode. The first component

$$( \frac{\frac{\vec{p} \cdot \vec{a}}{{N}_{a = 2}} - \overline{p}}{\overline{p}} ) * ( 2 {N}_{a = 2} )$$

of the loss function may quantify the return over a daily investment plan while the second component

$${( 1 - \frac{{N}_{a = 2}}{15} )}^{2}$$

may reward or penalize infrequent or overly frequent purchasing decisions in the action vector.

Once the action sequences for each historical episode have been generated by the genetic algorithm in step 1004, method 1000 may proceed to a step 1006, wherein a deep learning model may be trained to learn ETF purchasing strategies across multiple episodes using the action sequences generated in step 1004. The deep learning model may be a neural network such as a feed-forward neural network (see, e.g., neural network 800 shown in FIG. 8).

The deep learning model may be trained using a set of training data. Each training data point in the training data set may comprise an action or a set of actions pulled from the action sequences generated by the genetic algorithm in step 1004. Additionally, each training data point may include information associated with the action or set of actions, such as stock market information from time or period of time corresponding to the action or set of actions, or stock market information from a window of time preceding the time or period of time corresponding to the action or set of actions. Information about financial events (e.g., other investments by the same investor), economic events, or political events that occurred at the time or period of time corresponding to the action or set of actions or in a window of time preceding the time or period of time corresponding to the action or set of actions may also be included in a training data point. Over the course of its training, the deep learning model may learn to predict days on which the ETF should (or should not) be purchased based on said information. The performance of the deep learning model may be evaluated by testing whether, for any given historical episode (or portion of a given historical episode), the model can recreate the action sequence (or portion of the action sequence) generated by the genetic algorithm.

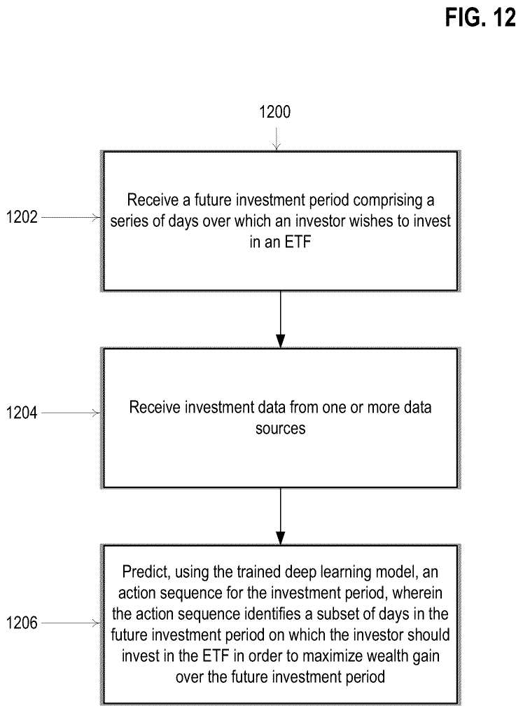

Finally, after the deep learning model has been trained in step 1006, method 1000 may proceed to step 1008, wherein the trained deep learning model may be used to predict ETF purchasing strategies for an upcoming period of time. The period of time may be the same as the period of time covered by the historical episodes for which the action sequences were generated (e.g., a thirty-day period), or may be a shorter or longer period of time (e.g., a single day, a week, several months, or several years). FIG. 12 shows a method 1200 for predicting an ETF purchasing strategy for an upcoming time period using a trained deep learning model, according to some embodiments of the present disclosure. In one or more examples, step 1008 of method 1000 may include one or more steps of method 1200.

As shown, in a first step 1202, an investor may provide the trained model with a future investment period that includes one or more days over which the investor wishes to invest in an ETF. Once the investment period of interest is received, method 1200 may proceed to step 1204, wherein investment data may be received by the deep learning model from one or more data sources. The investment data may include information such as the average price of the ETF over a period of time (e.g., a set of time units) preceding the future investment period, recent trends in the price of the ETF, information about recent investments made by the investor, political event information, economic event information, or any other data that may influence the price of the ETF and/or the outcome of an investment strategy for the investor. The data sources from which the investment data is received may include databases of stock market data, newspapers, databases of weather information, and/or the investor themselves.

Based on both the future investment period provided in step 1202 and the investment data received in step 1204, the trained deep learning model may predict an action sequence for the future investment period in step 1206. The predicted action sequence may identify a day or a subset of days in the future investment period on which the investor should purchase the ETF in order to maximize their wealth over the future investment period.

### Computer System

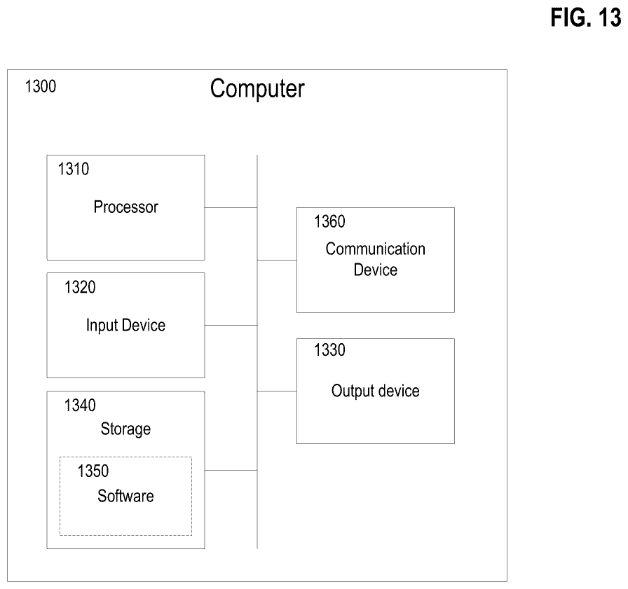

In one or more examples, the disclosed methods may be executed using a computer system. FIG. 13 illustrates an exemplary computing system according to examples of the disclosure. In one or more examples, computer 1300 may be involved in executing one or more of the methods described herein, such as method 300 shown in FIG. 3. Computer 1300 can be a host computer connected to a network. Computer 1300 can be a client computer or a server. As shown in FIG. 13, computer 1300 can be any suitable type of microprocessor-based device, such as a personal computer, workstation, server, or handheld computing device, such as a phone or tablet. The computer can include, for example, one or more of processor 1310, input device 1320, output device 1330, storage 1340, and communication device 1360. Input device 1320 and output device 1330 can correspond to those described above and can either be connectable or integrated with the computer.

Input device 1320 can be any suitable device that provides input, such as a touch screen or monitor, keyboard, mouse, or voice-recognition device. Output device 1330 can be any suitable device that provides an output, such as a touch screen, monitor, printer, disk drive, or speaker.

Storage 1340 can be any suitable device that provides storage, such as an electrical, magnetic, or optical memory, including a random-access memory (RAM), cache, hard drive, CD-ROM drive, tape drive, or removable storage disk. Communication device 1360 can include any suitable device capable of transmitting and receiving signals over a network, such as a network interface chip or card. The components of the computer can be connected in any suitable manner, such as via a physical bus or wirelessly. Storage 1340 can be a non-transitory computer-readable storage medium comprising one or more programs, which, when executed by one or more processors, such as processor 1310, cause the one or more processors to execute methods described herein.

Software 1350, which can be stored in storage 1340 and executed by processor 1310, can include, for example, the programming that embodies the functionality of the present disclosure (e.g., as embodied in the systems, computers, servers, and/or devices as described above). In one or more examples, software 1350 can include a combination of servers such as application servers and database servers.

Software 1350 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 1340, that can contain or store programming for use by or in connection with an instruction execution system, apparatus, or device.

Software 1350 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 1300 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1300 can implement any operating system suitable for operating on the network. Software 1350 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

### CONCLUSION

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for training a deep learning model comprising:
generating data representing a plurality of historical episodes, wherein each historical episode is divided into a sequence of time units, wherein historical information is associated with each time unit;
generating, using an evolutionary algorithm, for each historical episode of the plurality of episodes, a respective training action sequence comprising a respective sequence of actions that corresponds to the sequence of time units for the historical episode;
generating a training data set comprising a plurality of training data points wherein each of the plurality of training data points comprises an action extracted from a training action sequence generated by the evolutionary algorithm;
training a deep learning model using the training data set to generate future actions to be executed at current or future time units; and
generating, using the trained deep learning model, a future action for a current or future time unit.

2. The method of claim 1, wherein generating a historical episode of the plurality of historical episodes comprises:
receiving the historical information;
dividing the historical information into a first information subset associated with a first set of time units and a second information subset associated with a second set of time units, wherein the first set of time units and the second set of time units are consecutive;
determining a scale factor based on the first information subset;
scaling one or more values in the second information subset by the scale factor; and
outputting the second set of time units and the scaled second information subset as the historical episode.

3. The method of claim 1, wherein generating for each historical episode of the plurality of historical episodes, a respective training action sequence comprises:
randomly generating a set of candidate action sequences corresponding to the sequence of time units for the historical episode;
determining a set of fitness values, wherein each fitness value in the set of fitness values corresponds to a candidate action sequence in the set of candidate action sequences;
identifying, based on the set of fitness values, a fittest subset of the set of candidate action sequences;
generating an updated set of candidate action sequences by modifying candidate action sequences in the fittest subset;
iteratively repeating the steps of determining a set of fitness values, identifying a fittest subset, and generating an updated set of candidate action sequences; and
identifying, based on the iterative repeating process, a fittest candidate action sequence.

4. The method of claim 3, wherein the training action sequence for each historical episode is the fittest candidate action sequence corresponding to said historical episode that is identified by the evolutionary algorithm.

5. The method of claim 3, wherein the iteratively repeating continues until at least one cessation condition of plurality of cessation conditions is met, wherein the plurality of cessation conditions comprise:
a total number of iterations exceeds a threshold number of iterations, and one or more fitness values in the set of fitness values exceeds a threshold fitness value.

6. The method of claim 3, wherein modifying candidate actions sequences in the fittest subset comprises switching one or more actions in each action sequence of the fittest subset of from a first action type to a second action type.

7. The method of claim 3, wherein modifying candidate action sequences in the fittest subset of candidate action sequences comprises:
selecting a first set of actions from a first action sequence of the fittest subset;
selecting a second set of actions from a second action sequence of the fittest subset; and
combining the first set of actions and the second set of actions to form a third action sequence.

8. The method of claim 1, wherein the historical information associated with each time unit comprises a numerical value.

9. The method of claim 8, wherein each training data point of the plurality of training data points in the training data set further comprises an average value of the numerical value over a set of time units preceding a time unit in a historical episode of the plurality of historical episodes that corresponds to an action sequence from which the action in the training data point was extracted.

10. The method of claim 1, wherein training the deep learning model comprises, for each historical episode:
generating a predicted action sequence;
comparing the predicted action sequence to the training action sequence that corresponds to the historical episode;
adjusting one or more parameters of the deep learning model based on the comparison between the predicted action sequence and the training action sequence in the training data.

11. The method of claim 1, wherein the future action generated by the trained deep learning model is configured to maximize a reward for an entity for the current or future time unit.

12. The method of claim 1, wherein the historical information comprises market performance information.

13. The method of claim 12, wherein each training action sequence generated by the evolutionary algorithm comprises, for each time unit in the historical episode associated with the training action sequence, an indication of whether to execute a purchase of an ETF at that time unit.

14. The method of claim 13, wherein the future action for the current or future time unit that is generated by the deep learning model comprises an indication of whether to execute a purchase of the ETF at said time unit.

15. The method of claim 1, wherein the evolutionary algorithm is a genetic algorithm.

16. The method of claim 1, wherein the deep learning model is a neural network.

17. The method of claim 16, wherein the deep learning model is a feed-forward neural network.

18. The method of claim 17, wherein the feed-forward neural network comprises at least six layers.

19. The method of claim 17, wherein the feed-forward neural network utilizes a rectified linear unit (ReLU) activation function at one or more layers.

20. A system for training a deep learning model comprising:
a user interface;
one or more processors communicatively coupled to the user interface and configured to:
generate data representing a plurality of historical episodes, wherein each historical episode is divided into a sequence of time units, wherein historical information is associated with each time unit;
generate, using an evolutionary algorithm, for each historical episode of the plurality of episodes, a respective training action sequence comprising a respective sequence of actions that corresponds to the sequence of time units for the historical episode;
generate a training data set comprising a plurality of training data points wherein each of the plurality of training data points comprises an action extracted from a training action sequence generated by the evolutionary algorithm;
train a deep learning model using the training data, to generate future actions to be executed at current or future time units; and
generate, using the trained deep learning model, a future action for a current or future time unit; and
output, using the user interface, the future action to a user.

21. A non-transitory computer readable storage medium storing instructions that, when executed by one or more processors of an electronic device, cause the electronic device to:
generate data representing a plurality of historical episodes, wherein each historical episode is divided into a sequence of time units, wherein historical information is associated with each time unit;
generate, using an evolutionary algorithm, for each historical episode of the plurality of episodes, a respective training action sequence comprising a respective sequence of actions that corresponds to the sequence of time units for the historical episode;
generate a training data set comprising a plurality of training data points wherein each of the plurality of training data points comprises an action extracted from a training action sequence generated by the evolutionary algorithm;
train a deep learning model using the training data set to generate future actions to be executed at current or future time units; and
generate, using the trained deep learning model, a future action for a current or future time unit.
